(19) United States
(12) Patent Application Publication
(10) Pub. No.: US 2005/0197860 A1
(43) Pub. Date: Sep. 8, 2005

(54) Data management system

(75) Inventors: Alexander Joffe, Thousand Oaks, CA (US); Samuel Thomas Coroniti, Thousand Oaks, CA (US); Daniel Alan Wilson, Camarillo, CA (US); C. Mike Tomlinson, Thousand Oaks, CA (US); Max Stanford Tomlinson JR., Thousand Oaks, CA (US)

Correspondence Address: FITZPATRICK CELLA HARPER & SCINTO, 30 ROCKEFELLER PLAZA, NEW YORK, NY, 10112, US

(73) Assignee: RadEMR, Inc., Camarillo, CA (US)

(21) Appl. No.: 10/782,904

(22) Filed: Feb. 23, 2004

(51) Int. Cl. G06F 17/60

(52) U.S. Cl. 705/2

(57) ABSTRACT

A data management system includes a server system and a data forwarding unit for forwarding data to the server system via a public network. The server system includes a storage system for storing data, an information system for storing information on data managed by the data management system, and a plurality of interfaces for accessing the server system via the public network. When the data forwarding unit receives data, identification information on the received data is sent to the information system via one of the plurality of interfaces selected by the data forwarding unit in accordance with a set of predetermined rules. In response to receiving identification information from the data forwarding unit, the information system sends communication information for one of the plurality of interfaces selected by the information system in accordance with a set of predetermined rules. Using the communication information, the data forwarding unit forwards the received data to the storage system for storage via the interface selected by the information system.

### BACKGROUND OF THE INVENTION

1. Field of the Invention

The present invention concerns a data management system, and in particular concerns a system for storing and managing data forwarded to a server system via a public network by a data forwarding unit.

2. Description of the Related Art

Modern medical imaging systems provide valuable diagnostic tools to assist doctors and radiologists in diagnosing and treating patients. Modalities such as magnetic resonance imaging (MRI), ultrasound, computed tomography (CT) and x-ray imaging provide accurate, non-invasive techniques for examining patients. However, the need to view medical images generated using these modalities and their associated reports often goes beyond that of radiologists and attending physicians.

In the current healthcare system, a significant percentage of medical services are paid for by medical liability carriers on behalf of patients. These medical liability carriers include commercial insurance organizations that underwrite workers compensation, personal injury, disability, automotive, casualty and other lines of businesses that have medical claims attached. Also included are group health plans that use medical data for retrospective utilization review and medical management organizations that provide case and disease management services to the groups and organizations mentioned above. These medical liability carriers are generally referred to as payers.

When handling patient claims, payers usually obtain copies of both the medical images generated for purposes of treating a particular patient and the reports associated with those medical images. The medical images and associated reports are then reviewed by a number of different parties, including but not limited to medical management partners, referring physicians, attorneys, or the patients themselves.

Traditionally, payers have obtained hard copies (i.e., film and paper) of the medical images and reports for their review processes. As more and more copies of medical images become necessary, the costs associated with obtaining the copies and transporting them to the various reviewing parties become significant. Furthermore, state and federal laws concerning the storage and security of medical records create additional challenges that consume valuable resources.

The replacement of traditional film medical images with digital medical images potentially reduces some of the burdens described above by allowing electronic transfer and storage of images and their associated reports. However, this transition to digital medical data has additional obstacles that many payers are either unwilling or unable to overcome. First, storage and security requirements for medical records still apply to digital medical data. The costs associated with obtaining and maintaining the hardware and software needed to satisfy these requirements and for facilitating access to the stored digital medical data are prohibitive to many payers.

Second, payers usually obtain digital medical data from more than one medical facility and must establish a secure means for communicating with each medical facility in order to receive digital medical data. Independent medical facilities may use different types of networks and communication protocols. In addition, different makes and models of imaging equipment often require different configurations for communicating with the equipment. Accordingly, setting up direct communication links to obtain digital medical data from multiple medical facilities can be both difficult and expensive.

Therefore, a need exists for a secure and reliable data management system for storing digital medical data generated by multiple medical facilities and providing access to the stored digital medical data for payers and other authorized individuals.

### SUMMARY OF THE INVENTION

The present invention proposes a data management system that includes a server system and a data forwarding unit for forwarding data to the server system via a public network. The server system includes a storage system for storing data, an information system for storing information on data managed by the data management system, and a plurality of interfaces for accessing the server system via the public network. When the data forwarding unit receives data, identification information on the received data is sent to the information system via one of the plurality of interfaces selected by the data forwarding unit in accordance with a set of predetermined rules. In response to receiving identification information from the data forwarding unit, the information system sends communication information for one of the plurality of interfaces selected by the information system in accordance with a set of predetermined rules. Using the communication information, the data forwarding unit forwards the received data to the storage system for storage via the interface selected by the information system.

Preferably, the server system includes multiple redundant interfaces for accessing the information system via the public network and multiple redundant interfaces for accessing the storage system via the public network. In addition, it is preferable that data received by the data forwarding unit is sent to the server system when the identification information sent to the information system corresponds with the stored information on managed data, and that the received data is deleted when the identification information does not correspond. Furthermore, it is preferable that the storage system includes multiple different data storage devices, where data is stored in different ones of the devices in accordance with an assigned priority.

This brief summary of the invention has been provided so that the nature of the invention can be understood quickly. A more complete understanding of the invention can be obtained by reference to the detailed description of the invention below in connection with the accompanying drawings.

### BRIEF DESCRIPTION OF THE DRAWINGS

FIG. 1 is a block diagram depicting an operating environment of the invention.

FIG. 2 is a block diagram depicting a configuration of an imaging facility.

FIG. 3 is block diagram depicting a portion of the internal architecture of a server used in the present invention.

FIG. 4 is a block diagram depicting a configuration of a central server system.

FIG. 5 is a flowchart depicting a process of receiving image data from an imaging facility.

FIG. 6 is a flowchart depicting a process of forwarding image data to a central server system.

FIG. 7 is a block diagram depicting a configuration of an operating environment of the invention.

FIG. 8 is a flowchart depicting a process of selecting and viewing stored image data and associated studies by an authorized user.

### DETAILED DESCRIPTION OF THE INVENTION

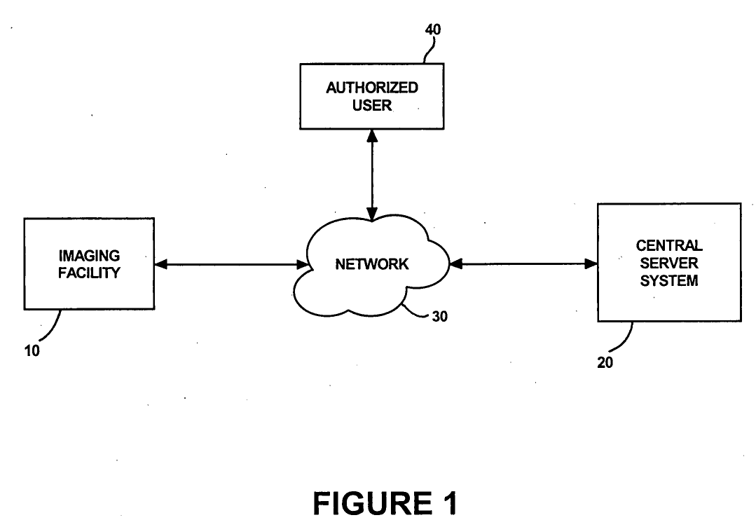

FIG. 1 is a block diagram depicting one example of an environment in which the present invention operates. As shown in FIG. 1, imaging facility 10, central server system 20 and authorized user 40 are connected to each other via network 30, through which communications and data transfers are made. For purposes of describing the present invention, only one of each of imaging facility 10, central server system 20 and authorized user 40 are depicted in FIG. 1. However, it is to be understood that multiple imaging facilities, central server systems, and authorized users can be interconnected via network 30 without departing from the scope of the current invention described below.

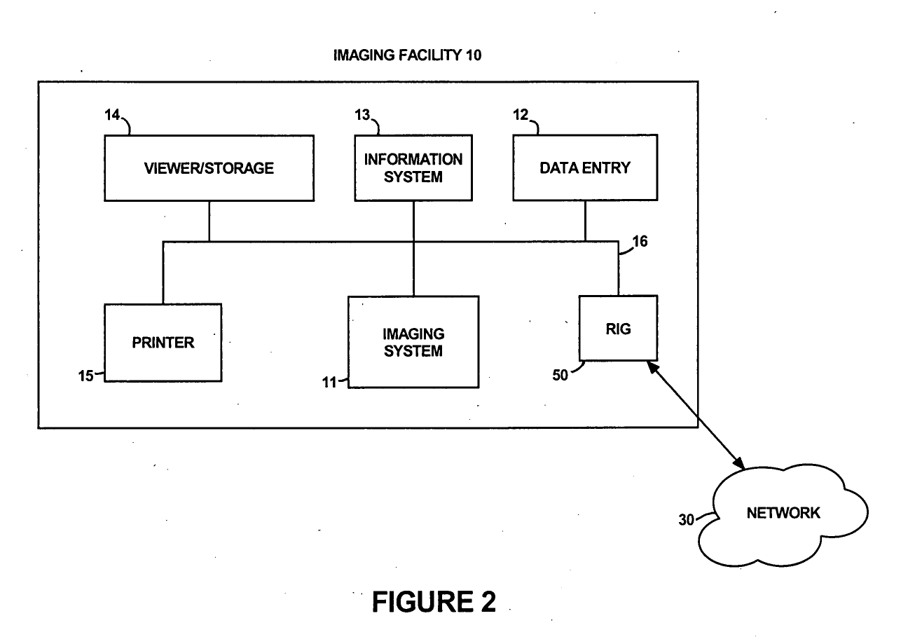

FIG. 2 is a block diagram depicting one possible configuration of imaging facility 10. As shown in FIG. 2, imaging facility 10 includes imaging system 11, data entry system 12, information system 13, viewer/storage system 14, printer 15, network 16 and remote image gateway (RIG) 50.

Imaging system 11 is a system used to obtain digital medical image data for a patient using a modality such as magnetic resonance imaging (MRI), ultrasound, x-ray imaging, or computed tomography (CT). While imaging facility 10 is depicted as having a single image system 11, multiple imaging systems 11 may be included to provide capability for multiple modalities. Data entry system 12 is a computer or workstation with which an employee of imaging facility 10 can enter demographic data such as patient name, date, exam type, doctor, etc., to be associated with digital medical image data obtained using imaging system 11.

Information system 13 is a software system for managing the workflow of imaging facility 10. Information System 13 may be either a radiology information system (RIS) or a hospital information system (HIS). Functions of information system 13 include tracking and storing radiology reports created by doctors or radiologists after reviewing digital medical image data acquired using imaging system 11. Viewer/storage system 14 is a system such as a picture archiving and communication system (PACS) for storing digital medical image data and related radiology reports onsite at imaging facility 10. Viewer/storage system 14 allows employees of the facility to retrieve and review locally stored digital medical data. Printer 15 is a printing system used to produce hard copies of the digital medical image data. Network 16 is a communication network such as a LAN that facilitates communication and data transfer between the various components of imaging facility 10.

RIG 50 is a store and forward device that receives digital medical image data generated by imaging system 11 via network 16 and forwards the digital medical image data to central server system 20 via network 30. The manner in which data is stored and forwarded is described in more detail below. RIG 50 is a computing system programmed and configured to perform three primary functions: acquire digital medical image data generated by imaging facility 10, forward digital medical image data to central server system 20, and manage internally stored digital medical image data.

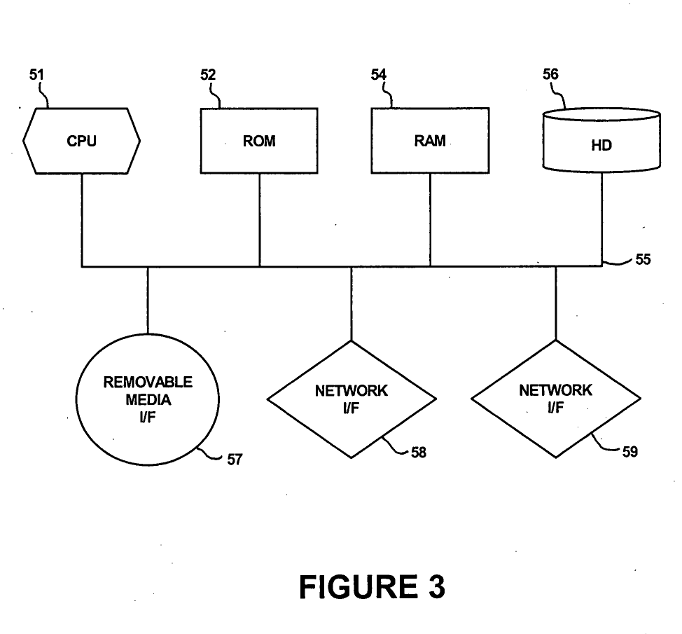

FIG. 3 is a block diagram illustrating a portion of the architecture of a computing system used to implement RIG 50. Central processing unit (CPU) 51 is a microprocessor that executes instructions loaded from stored computer programs. CPU 51 is interfaced to bus 55 which provides for communication and transfer of data between components of the computing system. Read only memory (ROM) 52 stores invariant instruction sequences, such as startup instruction sequences for CPU 51 and basic input/output operating system (BIOS) sequences for the computing system. Random access memory (RAM) 54 is a run-time memory in which instruction sequences are loaded from fixed disk 56, or another form of computer-readable storage media, by CPU 51 prior to being executed. Additionally, RAM 54 provides memory space for CPU 51 to execute instruction sequences and perform computations.

Fixed disk 56 is a computer-readable storage medium that stores software that is executed to implement the primary functions of RIG 50. The software includes an operating system such as Linux, communication software for facilitating communications with imaging facility 10 via network 16, communication software for communications with central server system 20 via network 30, and data management software for managing data stored in the computing system. Fixed disk 56 also provides storage space for data received and generated by the computing system. Stored data includes configuration files, activity logs, digital medical image data, and tables used by the communication software. The operation of the software and the use of the stored data are described in more detail below.

Removable storage media interface 57 provides access to one or more forms of removable computer-readable storage media. Possible types of removable storage media include, but are not limited to, optical storage media, floppy disks, flash memory devices, etc. While the computing system has been described as storing the software and data on fixed disk 56, all or a portion of this data can also be stored and accessed on removable storage media.

Also interfaced to bus 55 are network interface 58 and network interface 59 for interfacing with up to two networks. For example, in one embodiment of the invention, network interface 58 is connected to network 16 to facilitate communications between RIG 50 and imaging facility 10, and network interface 59 is connected to network 30 to facilitate communications between RIG 50 and central server system 20.

As described above, RIG 50 is implemented as a computing system that is installed in imaging facility 10 by connecting the computing system to network 16. Alternatively, the software and data used to implement RIG 50 can be installed on an existing computing system having dual network interfaces within imaging facility 10. In this manner, the present invention can be implemented without requiring additional hardware to be installed at imaging facility 10.

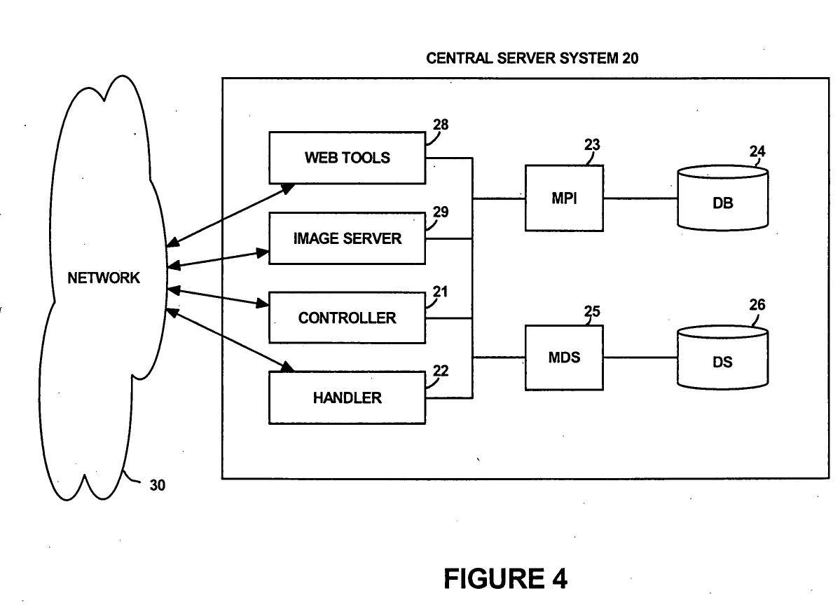

FIG. 4 is a block diagram depicting the components of central server system 20. As shown in FIG. 4, central server system 20 includes controller 21, handler 22, master patient index (MPI) 23, database 24, medical data store (MDS) 25, data store 26, web tools 28 and image server 29. For purposes of this description, only one of each of the foregoing components is depicted in FIG. 4. It is to be understood, however, that more than one of the foregoing components can and preferably are included in implementations of the present invention.

Controller 21 and handler 22 are interfaces/gateways between network 30 and central server system 20. Controller 21 is a non-file transport mechanism for passing through non file-transfer communications sent and received by central server system 20 via network 30 and communications sent between components within central server system 20. Handler 22 is a file transport mechanism for passing through file transfer communications sent and received by central server system 20 via network 30. Controller 21 and handler 22 are implemented with communications software executed on respective computing systems that provide both a physical layer and a logical layer between the data stored in central server system 20 and network 30. Preferably, the communications software executed in controller 21 and handler 22 utilizes an open architecture protocol such as the Simple Object Access Protocol (SOAP), or one built on SOAP, to pass through communications in the same format as they were received.

Master patient index (MPI) 23 and medical data store (MDS) 25 are agents for accessing and managing data stored in database 24 and data store 26, respectively. MPI 23 and MDS 25 are implemented with software executed on respective computing systems, which provide an additional physical layer and logical layer between network 30 and the data stored in database 24 and data store 26. Both MPI 23 and MDS 25 utilize communications software based on an open architecture protocol such as SOAP for sending and receiving communications via controller 21 or handler 22. MPI 23 accesses and manages the data stored in database 24 using an open database connectivity application. MDS 25 accesses and manages the data stored in data store 26 using a network file system.

Together with MDS 25, data store 26 provides a storage system for storing data within a central server system. Specifically, data store 26 stores digital medical image data received by central server system 20 via network 30 together with reports associated with the digital medical image data. Data store 26 is implemented using multiple storage elements have varying storage capacities and access times, such as disk arrays, optical media storage, and tape libraries. Digital medical image data and associated reports are stored in data store 26 based on static policies and dynamic parameters such as storing data that is higher in demand in storage elements having quick access times, such as a disk array, and storing data that is low in demand in storage elements having slower access times, such as a tape library.

Together with MPI 23, database 24 provides an information system that contains information on what data is stored in the central server systems of the invention and where the data is stored. Specifically, database 24 is an indexing engine which maintains information on the digital medical image data and reports stored in data store 26. Database 24 also stores account privileges, user logs and data access logs such as protected health information access in order to comply with state and federal laws. In addition, database 24 stores software to facilitate configuring RIG 50 as well as updating the software executed on RIG 50. Database 24 further contains demographic information on patients, facilities, physicians and payers for use in identifying desired digital medical image data received by central server system 20 and correlating stored digital medical image data with radiology reports received by central server system 20, which will be discussed in more detail below.

Web tools 28 provides user interfaces via network 30 for authorized user 40 to access and view digital medical data stored in central server system 20. In addition, web tools 28 provides user interfaces to manage account preferences of authorized user 40 and to manage the dissemination of the digital medical data associated with authorized user 40. Web tools 28 is a web server that implements these user interfaces by executing CGI scripts in association with stored web pages.

Image server 29 is a server for providing digital medical image data stored in data store 26 to be viewed by authorized user 40 using an image viewer such as a web browser. Image server 29 is implemented with an image server application executed on a computing system. Image server 29 encrypts all data sent to an image viewer such that no data is retained in readable format on a user's computing system after a viewing session has been ended by the user.

Network 30 is a public communication network that facilitates communication to and from image facility 10, central server system 20 and authorized user 40. Preferably, network 30 is the Internet. However, other types of wide-area networks that connect one or more imaging facilities, central server systems and authorized users can be used without departing from the scope of the invention.

Authorized user 40 represents individuals and business entities authorized to access and view medical data of specified patients, and in particular are authorized to view digital medical data generated by imaging facility 10 for those specified patients. Primarily, authorized users are payers, as defined above. However, payers may authorize other parties, such as doctors, radiologists, attorneys, imaging facilities, and patients, to access the digital medical image data, as explained in more detail below.

A fee is charged for payers to access and view the digital medical image data and associated reports stored on central server system 20. The fee may be a flat fee granting unlimited access to all digital medical image data a particular payer is authorized to review. Alternatively, the fee may be based on a usage formula or any other fee arrangement to which the payer agrees.

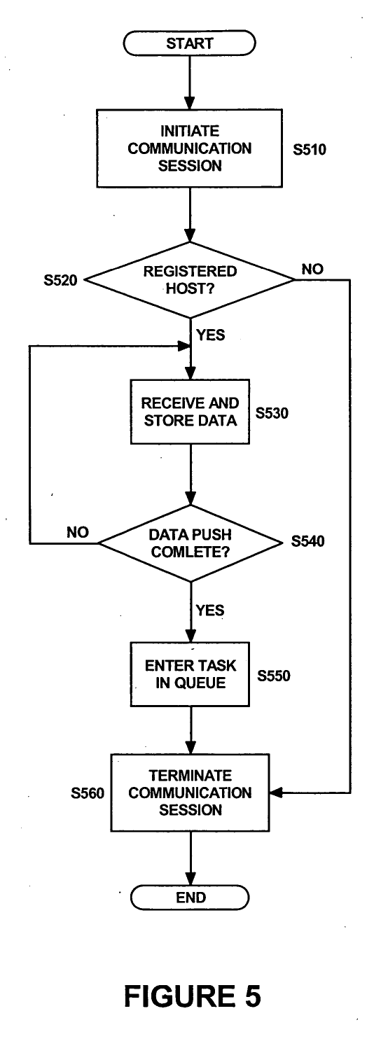

As described above, RIG 50 performs three primary functions: acquire digital medical image data, forward the digital medical image data to central server system 20, and manage the digital medical image data stored on RIG 50. Each of these functions are executed concurrently and operate independently of each other. FIG. 5 is a flowchart depicting the operation of RIG 50 acquiring digital medical image data from imaging facility 10. RIG 50 is installed at imaging facility 10 by connecting RIG 50 to network 16 and network 30 and executing a startup routine to enter a normal operation mode. Alternatively, RIG 50 is installed by installing the necessary software on an existing computing system in imaging facility 10.

Preferably, imaging system 11 generates and transmits digital medical image data using the Digital Imaging and Communications in Medicine (DICOM) protocol. RIG 50 is a DICOM storage class provider and as such accepts DICOM sessions and data from DICOM compatible devices entered into a host table stored in RIG 50. Accordingly, when RIG 50 is installed at imaging facility 10, its host table is updated with the DICOM compatible devices, such as imaging system 11, currently in use at imaging facility 10. If DICOM compatible devices are added or removed from network 16, the host table of RIG 50 is updated accordingly.

Once imaging system 11 has completed the capture of a digital medical image, or a series of images, for a particular patient, a DICOM protocol communication session is initiated between imaging system 11 and RIG 50 via network 16 in step S510. In step S520, RIG 50 determines whether imaging system 11 that is initiating the communication session is registered on the host table of RIG 50. If imaging system 11 is not registered in the host table, the communication session is terminated in step S560. If imaging system 11 is registered in the host table, the communication session is accepted by RIG 50 and the series of digital medical image data is pushed to RIG 50 in step S530. RIG 50 stores the series of digital medical image data in a unique set of directories and files on RIG 50 and generates appropriate indexing files for the stored data.

In step S540, RIG 50 determines whether the complete series of digital medical image data has been received and stored. If the all of the data has been received and stored, a task to forward the received series of digital medical image data is entered in a task queue of RIG 50 in step S550. The task queue of RIG 50 is used to store tasks to be performed by RIG 50 in a specified order. The task to forward the stored digital medical image identifies the unique directories and files in which the data is stored and includes a request to forward the data to central server system 20. Other possible tasks placed in the queue include maintenance tasks, configuration tasks, software update tasks, etc. Once the task has been entered in the task queue, the communication session with imaging system 11 is terminated in step S560.

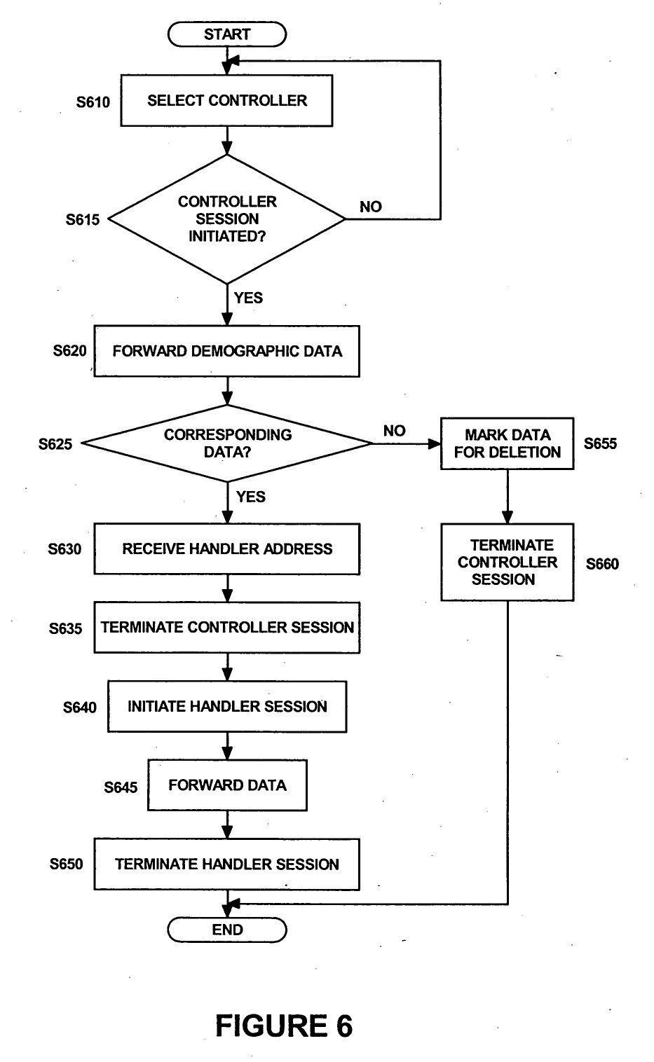

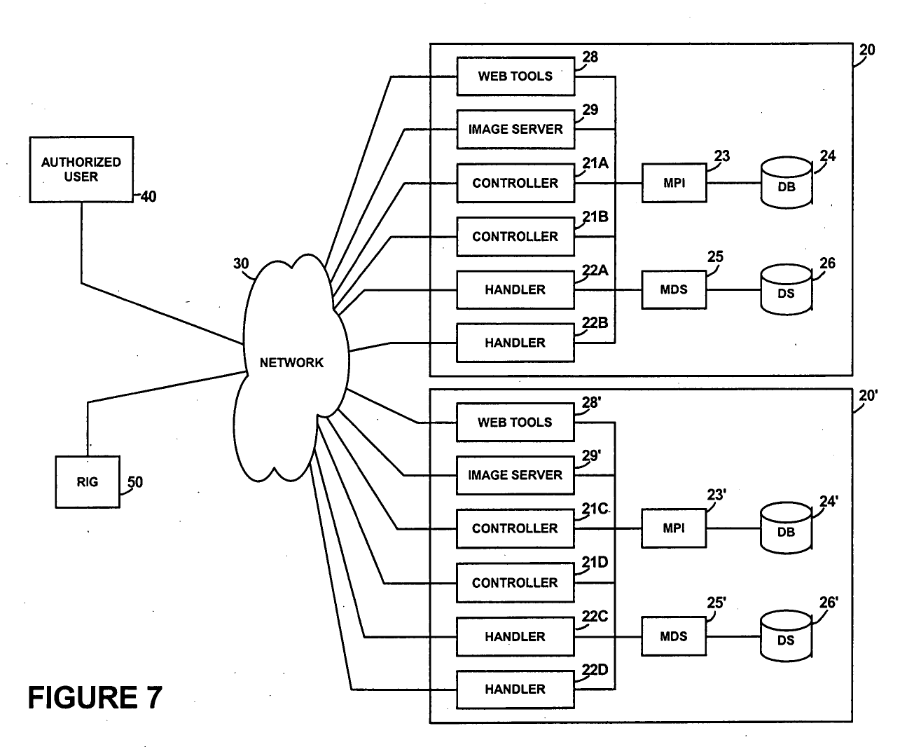

FIG. 6 is a flowchart depicting the operation of RIG 50 forwarding digital medical image data to central server system 20. The steps depicted in FIG. 6 are described below with reference to FIG. 7, which depicts an embodiment of the present invention utilizing two central server systems 20 and 20′. It is to be understood, however, that the present invention is not limited the system depicted in FIG. 7. For example, more than two controllers and handlers can be implemented in each central server system. In addition, the number of RIGs, authorized users and central server systems may vary from that shown without departing from the scope of the present invention.

When RIG 50 executes a task from the task queue of forwarding digital medical image data to a central server system, RIG 50 first selects a controller with which to initiate communications in step S610. To make this selection, RIG 50 refers to a list of trusted network addresses to identify a preferred controller of a central server system. As mentioned above, and shown in FIG. 7, the environment of the present invention may include multiple central server systems (20 and 20′) with multiple redundant controllers incorporated in each system. The list of trusted network addresses identifies the addresses of all the currently active controllers (21A to 21D). The addresses are ordered using a dithering method or a round-robin method in order to provide a passive type of load balancing between all controllers, where the preferred controller is the next controller on the list. Other methods might also be used to order the list of trusted network address for the controllers. As controllers and central server systems are added or removed, the list stored on the RIG 50 is updated to reflect changes to the overall system.

RIG 50 is configured to allow only self-initiated communication sessions over network 30. This feature provides two primary security advantages for using RIG 50 to capture digital medical image data. First, by not allowing outside entities to initiate contact with RIG 50, the possibility of unauthorized access to RIG 50 and any data stored thereon is greatly reduced. Second, RIG 50 does not require static addressing and can be placed behind security measures such as a firewall put in place at imaging facility 10 without interfering with their operation.

After RIG 50 has selected a controller using the list of trusted network addresses, RIG 50 opens an outbound port to establish a secure communication channel with the controller in step S615. Preferably, the communication channel is secured with a handshake routine using client and server security certificates exchanged between RIG 50 and the selected controller at the beginning of the session, and using 128 bit secure socket layer encryption during the session.

If a communication channel cannot be established between RIG 50 and the selected controller in step S615, the process returns to step S610 and RIG 50 selects the next controller on the list. The communication channel might be denied for a number of reasons. For example, the selected controller might not be operational or incapable of opening an additional communication channel. Even if the selected controller is available, the request to open a communication channel with RIG 50 is denied if the MPI or MDS of the selected controller's central server system is not operational or not available. If a communication channel cannot be established with any of the listed controllers, RIG 50 starts over at the beginning of the list after a set timeout period has expired. The timeout period is configurable and is adjusted based on the overall system performance and the number of attempts previously made.

Communications between RIG 50 and controllers and handlers utilizes an open architecture protocol preferably built on SOAP. Upon receiving a request to open a communication channel with RIG 50, the selected controller launches an instance of the communication software used to implement the controller. Each controller in the system is capable of simultaneously launching multiple instances of the software to provide multiple communication channels at any given time.

Once a secure communication channel between RIG 50 and the selected controller has been established in step S615, RIG 50 provides the controller with information on the digital medical image data identified in the task being performed in step S620. In particular, RIG 50 provides the controller with a description of the image data as well as the demographic information associated with the image data.

The selected controller passes the received information onto MPI 23. Upon initiating communication with MPI 23, an instance of the software used to implement MPI 23 is launched to facilitate the communications from the controller. Communications with MPI 23 is performed using an open architecture protocol preferably built on SOAP such as the one used for communications between RIG 50 and the controllers. MPI 23 is capable of simultaneously launching multiple instances of the software to allow multiple controllers to communicate with MPI 23 at any given time. In step S625, MPI 23 compares the information passed through by the controller with that stored in database 24 to determine if specified criteria of the digital medical image data and the information stored in database 24 correspond. The specified criteria include, but are not limited to, patient name, ordering physician, imaging facility, insurance provider, date, etc. The criteria are specified in database 24 in order to assist in identifying digital medical image data ordered by payers affiliated with the system.

The demographic information stored in database 24 is maintained to include information on studies ordered for patients by payers affiliated with the system. For example, payers can provide the demographic information for each study they order for an administrator of a central server system to manually input into database 24. Alternatively, database 24 can receive the demographic information directly from an electronic data interchange that securely transfers the information to database 24 from a payer's information system. With access to payers' information systems, central server system 20 can know which studies have been ordered from particular imaging facilities for particular patients.

If it is determined in step S625, that the received digital medical image data does not correspond with the specified criteria, the received medical image data is marked for deletion in step S655 and the communication session with the controller is terminated in step S660. On the other hand, if it is determined in step S625 that the received digital medical image data does correspond with the specified criteria, in step S630 MPI 23 using database 24 identifies an available handler and provides RIG 50 via the selected controller with the address of the handler and an instruction to transmit the received digital medical image data to that handler. MPI 23 selects an available handler from a list of handlers that is ordered so as to provide a type of passive load balancing between the available handlers. RIG 50 then terminates the controller communication session in step S635.

In step S640, RIG 50 establishes a secure communication channel between RIG 50 and the identified handler in the same manner as that used to establish the secure communication channel with controller. The handler launches an instance of the communication software used to implement the handler when the request to establish a communication channel is received. Each handler is capable of simultaneously launching multiple instances of the software to facilitate multiple communication channels at any given time. Once a secure communication channel has been established with the handler, RIG 50 transmits the digital medical image data to handler preferably using 128 bit secure socket layer encryption in step S645. Handler passes the transmitted digital medical image data to MDS 25. MDS 25 launches an instance of the software used to implement MDS 25 upon receiving a request from the handler to transmit data. MDS 25 is capable of simultaneously launching multiple instances of the software to facilitate communications with multiple handlers at any given time. MDS 25 stores the image data in data store 26 as a bitwise copy of the original data. After the digital medical image data has been successfully transmitted and stored in data store 26, the handler communication session is terminated in step S650.

As shown in FIG. 7, one example of the present invention utilizes two central server systems. Within each central server system in this example there are two redundant controllers and two redundant handlers. If one of the two is not operational at any given time, the other can be used to communicate with RIG 50 and thereby maintain system operations. The data stored in databases 24 and 24′ is maintained to be the same. Updates between the two databases occurs on a transactional basis. Accordingly, whenever a change has been completed in database 24, the same change is made in database 24′. The data stored in data store 26 and data store 26′ is also maintained to be the same. However, the updates between the two data stores is performed at a configured timing (hourly, daily, weekly, etc.) that can be set based on factors such as network capabilities or traffic patterns. By using redundant central server systems, that each include redundant components, the system can automatically compensate for failed components and provide backup data storage.

In addition to initiating communications with a central server system when a task to forward digital medical image data is executed, RIG 50 periodically contacts a central server system to provide status information. The status information is forwarded via a secure communication channel established with a controller in the same manner as that used to initiate communications with a controller to forward digital medical image data. Once a secure communication channel has been established and the status information forwarded, the selected controller can pass tasks to be placed in the task queue of RIG 50 from MPI 23. These tasks include, but are not limited to, adjusting the configuration and parameters used by RIG 50, updating the software executed on RIG 50, providing additional status information, and uploading activity logs of RIG 50. The time period in which communications are initiated to provide status information can be adjusted based on factors such as system performance and system activity.

As indicated above, digital medical image data received by RIG 50 is stored in a unique directory and file structure on RIG 50. Preferably, RIG 50 is configured with sufficient data storage capacity to store multiple days worth of digital medical image data generated by imaging facility 10. Accordingly, RIG 50 can continue to receive data for a period of time when communications with a central server system cannot be established. In order to recover storage resources for RIG 50 to maximize the amount of digital medical image data that can be received, data management is continuously performed by RIG 50 to remove data according to a configurable set of rules.

For example, data that has been marked for deletion during the data forwarding process is removed from RIG 50. Data that has already been transmitted to a central server system is examined to determine if a set time to live for that data has expired. The time to live is a configurable parameter of RIG 50 that determines how long data is retained after it has been transmitted to a central server system. The time to live can be reset at any time and can be adjusted based on the available storage of RIG 50. If the set time to live has expired, the associated data is removed from RIG 50 to free up storage space. If the storage capacity of RIG 50 is full or beyond a set threshold level and the stored data has been transmitted to a central server system, the data that has been transmitted is removed from RIG 50. Finally, if the storage capacity of RIG 50 is full and none of the data stored thereon has been transmitted to a central storage server RIG 50 does not accept any further DICOM associations until there is available storage capacity.

In addition to providing payer access to digital medical image data, the present invention also provides payer access to radiology reports associated with particular studies of medical images. Radiologists review and analyze studies of medical images and produce these reports based on their observations. Typically, a transcriptionist prepares the reports using notes or dictation provided by the radiologist who reviewed the medical images and returns the reports to the radiologist or directly to the imaging facility. The transcriptionist produces the reports either in an electronic format or in a hard-copy format that is scanned to produce an electronic version.

As mentioned above, web tools 28 is a web server that provides a user interface for accessing the data stored in central server system 20. According to the invention, web tools 28 provides a web-based user interface accessible via network 30 using a web browser executed on a computing device connected to network 30. Access to the user interface is password protected with varying levels of access to the stored data of central server system 20 being assignable to different users. User names, passwords, and assigned levels of access are stored in database 24.

Upon receiving a radiology report, the radiologist or an administrator at imaging facility 10 launches a web browser on a computing device connected to network 30 and enters a username and password in a login screen generated by web tools 28. Web tools 28 encrypts and transmits the entered username and password to MPI 23 through controller 21. MPI 23 then compares the username and password with those stored in database 24 to determine the level of access to data stored in central server system 20 that has been granted to the radiologist or administrator. Once access has been determined, web tools 28 queries MPI 23 via controller 21 for a listing of digital medical image data stored in data store 26 that the radiologist or administrator is authorized to access. For example, an administrator may be authorized to access all digital medical image data that was generated and uploaded from the imaging facility the administrator is affiliated with.

Web tools 28 provides the listing of authorized digital medical image data to the radiologist or administrator in the user interface. The radiologist or administrator then locates stored digital medical image data corresponding to the medical images reviewed to produce the radiology report. Once a match has been found, the radiologist or administrator uses the user interface and uploads the radiology report to web server 28. Web server 28 sends file information to MPI 23 via controller 21 which stores the information in database 24. MPI 23 then provides web server 28 with the address of handler 22 that web server 28 should then upload the file to. Web server 28 then sends the radiology report to data store 26 via handler 22. Handler 22 then sends file storage location information and confirmation of receiving the file to MPI 23. MPI 23 stores the file storage location information in database 24 to facilitate future retrieval of the radiology report together with its matching digital medical image data.

Alternatively, database 24 may receive information linking particular radiology reports with stored digital medical image data direction from an electronic data interchange that securely transfers the information to database 24 from the imaging facility's information system. In this manner, the radiologist or administrator uploads the radiology report to data store 26 using the user interface generated by web tools 28 while the electronic data interchange provides the linking information to database 24.

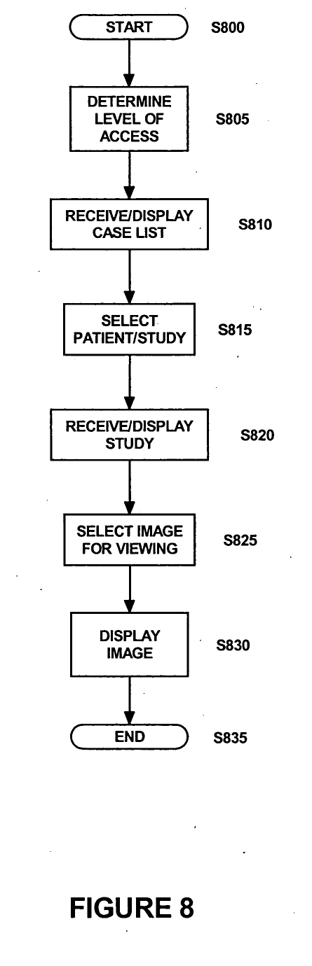

FIG. 8 is a flowchart depicting the process of authorized user 40 accessing and viewing a particular study of digital medical image data and its associated radiology reports. In step S800, authorized user 40 launches a web browser on a computing device connected to network 30 and enters a username and password in a login screen generated by web tools 28. In step S805, it is determined what level of access is available to authorized user 40 based on the submitted username and password. To determine the level of access, web tools 28 encrypts and transmits the username and password to MPI 23 through controller 21 and MPI 23 compares the username and password with those stored in database 24. Once a match and level of access has been determined, web tools 28 queries MPI 23 via controller 21 for a case list from database 24 based on the determined level of access. Web server 28 displays the case list in the web browser for authorized user 40 to view in step S810.

The case list is a list of all cases to which authorized user 40 has at least partial rights to access and view. The case list is displayed in accordance with the current settings associated with authorized user 40 stored in database 24. For example, the case list may be ordered based on patient name, modality of study, referring doctor, or date of the study. Using the case list, authorized user 40 selects a desired patient and study in step S815 and the selection is forwarded to MPI 23 by web tools 28 via controller 21. MPI 23 retrieves the location of the digital medical image data and associated radiology reports and demographic data associated with the selected study and returns the location to web tools 28 via controller 21. Web tools 28 sends a request to MDS 25 via the handler 22 where the data is located to retrieve the associated reports from data store 26. Web tools 28 sends the location of the digital medical image data to image server 29 via controller 21, and image server 29 then requests and receives the digital medical image data from MDS 25. The radiology report, demographic data and thumbnail image of the digital medical image data are displayed by web tools 28 in step S820.

To view the digital medical image data associated with the selected study, authorized user 40 selects the thumbnail image displayed with the study and image server 29 displays the digital medical image data for authorized user 40 using an image viewer in step S830. Before sending the image data to the viewer, image server 29 encrypts the image data so that the image data can only be viewed and not captured by authorized user 40. In addition, the encryption prevents a usable copy of the data being left on the authorized user's system. Once authorized user 40 has completed the review of the study, authorized user 40 logs out and closes the user interface in step S835. All communications between the web browser and the components of central server system 20 use a protocol such as 128 bit secure sockets layer.

In the foregoing manner, authorized user 40 can easily view digital medical image data regardless of the type of system used by the imaging facility 10 that originally generated the image data. Furthermore, the web based user interface provides an easy to use system for accessing and viewing studies without requiring specialized equipment or communications protocols. Finally, MPI 23 logs all activity of authorized user 40 through the user interface to generate audit logs of which stored data is accessed and who accessed the data.

In addition to case study and review, the web-based user interface generated by web tools 28 also includes other functionality available to authorized user 40. Other functionality includes managing account and user preferences such as password management and display preferences for the manner of displaying case lists and patient/study lists. In addition, authorized user 40 may be permitted to download the entire study in its original form.

If authorized user 40 has appropriate access rights and privileges, authorized user 40 can grant other users access to studies on their case list by “forwarding” the study to the intended users. Forwarding constitutes authorized user 40 granting access to a particular study to another individual. Preferably, the individual who has been forwarded the study is notified by email concerning the study and how to access it. Access may be granted to individuals who are currently authorized to access other studies or to individuals who have not had prior access. In addition, the access may be granted for a limited time, after which the study is no longer forwarded to that individual. The power to forward a study as well as limitations on the extent to which studies can be forwarded may vary or not be granted at all for different authorized users.

The foregoing describes the use of the invention for providing payer access to digital medical image data and its associated reports. In addition to this service, central server system 20 also provides secure, long-term storage of this data for both payers and imaging facilities. Accordingly, payers and imaging facilities may pay additional fees for storage of the digital medical data.

The invention has been described above with respect to particular illustrative embodiments. It is to be understood that the invention is not limited to the above-described embodiments and that various changes and modifications may be made by those skilled in the relevant art without departing from the spirit and scope of the invention.

1. A data management system, comprising:
a server system comprising:
a storage system for storing data;
an information system for storing information on data managed by said data management system; and
a plurality of interfaces for accessing said server system via a public network; and
a data forwarding unit for forwarding data to said server system via the public network,
wherein, when said data forwarding unit receives data, said data forwarding unit sends identification information on the received data to said information system via one of said plurality of interfaces selected by said data forwarding unit in accordance with a set of predetermined rules,
wherein, in response to receiving identification information from said data forwarding unit, said information system sends communication information for one of said plurality of interfaces selected by said information system in accordance with a set of predetermined rules to said data forwarding unit, and
wherein, using the communication information, said data forwarding unit forwards the received data to said storage system for storage via the interface selected by said information system.

2. A data management system according to claim 1, said plurality of interfaces comprising:
a plurality of first interfaces for accessing said information system via the public network; and
a plurality of second interfaces for accessing said storage system via the public network,
wherein the interface selected by said data forwarding unit is one of said plurality of first interfaces, and the interface selected by said information system is one of said plurality of second interfaces.

3. A data management system according to claim 2, wherein said plurality of first interfaces are redundant, and said plurality of second interfaces are redundant.

4. A data management system according to claim 1, wherein said information system compares the identification information received from said data forwarding unit with the stored information on data managed by said data management system, and sends the communication information for one of said plurality of interfaces if the received identification information corresponds with the stored information on managed data.

5. A data management system according to claim 4, wherein if the identification information received from said data forwarding unit does not correspond with the stored information on managed data, said data forwarding unit deletes the received data.

6. A data management system according to claim 1, said storage system comprising a plurality of different data storage devices.

7. A data management system according to claim 6, wherein data stored in said storage system is stored in different ones of said plurality of storage devices in accordance with a priority assigned to the data.

8. A data management system according to claim 1, wherein the received data stored in said storage system is stored bitwise in the same file format received by said data forwarding unit.

9. A data management system according to claim 1, wherein said data forwarding unit receives the data to be forwarded to said server system via a private network.

10. A data management system according to claim 1, wherein said data forwarding unit is configured to communicate via the public network using only self-initiated communication sessions.

11. A data management system according to claim 10, wherein communication sessions initiated by said data forwarding unit use an authenticated and secure protocol.

12. A data management system according to claim 10, wherein said data forwarding unit initiates a communication session with the interface selected by said data forwarding unit when said data forwarding unit receives data to be forwarded to said server system.

13. A data management system according to claim 10, wherein said data forwarding unit initiates a communication session with one of said plurality of interfaces selected by said data forwarding unit at a configured interval to forward status information to said information system.

14. A data management system according to claim 10, wherein said information system sends configuration instructions to said data forwarding unit when said data forwarding unit has initiated a communication session with said server system.

15. A data management system according to claim 10, wherein said information system sends programming instructions to said data forwarding unit when said data forwarding unit has initiated a communication session with said server system.

16. A data management system according to claim 1, further comprising a display unit for displaying data stored in said storage system,
wherein said display unit obtains the data to be displayed via one of said plurality
of interfaces identified by said information system in response to a request received from said display unit.

17. A data management system according to claim 16, wherein said display unit is a web browser.

18. A data management system according to claim 16, wherein the data obtained by said display unit is encrypted.

19. A data management system according to any one of claims 1 to 18, further comprising a plurality of said server systems,
wherein said plurality of server systems are physically remote from each other, and
wherein said data forwarding unit selects one of said plurality of interfaces of said plurality of server systems to send identification information on the received data in accordance with a set of predetermined rules.

20. A data management system according to claim 19, wherein information on data managed by said data management system is updated in said information system of each of said plurality of server systems when a change to the information is made in any one of said information systems.

21. A data management system according to claim 19, wherein data stored in said storage system of each of said plurality of server systems is periodically updated to reflect changes made to data stored in any one of said storage systems.
